(19) United States
(12) Patent Application Publication
(10) Pub. No.: US 2008/0181720 A1
(43) Pub. Date: Jul. 31, 2008

(54) Joint positioning structure

(75) Inventors: Hsiang-Lin Lee, Taichung County (TW); Cheng-I Teng, Taichung County (TW)

Correspondence Address: BACON & THOMAS, PLLC, 625 SLATERS LANE, FOURTH FLOOR, ALEXANDRIA, VA, 22314, US

(73) Assignee: MOBILETRON ELECTRONICS CO., LTD., TAICHUNG HSIEN (TW)

(21) Appl. No.: 11/698,827

(22) Filed: Jan. 29, 2007

(51) Int. Cl. B25G 3/18

(52) U.S. Cl. 403/322.1

(57) ABSTRACT

A joint positioning structure includes pivotally coupled first and second coupling members, and a locking mechanism. The locking mechanism includes a push rod moveably inserted through the first and second coupling members, a positioning member affixed to the first coupling member and having a plurality of radial locating slots, a stop block fixedly fastened to the push rod, and two engagement members, which are affixed to the stop block and engaged into the locating slots of the positioning member to lock the first and second coupling members when the stop member is moved with the push rod to a first position or disengaged from the locating slots of the positioning member to unlock the first and second coupling members for allowing relative biasing between the two coupling members when the stop member is moved with the push rod to a second position.

### BACKGROUND OF THE INVENTION

1. Field of the Invention

The present invention relates generally to a joint for use in an object and more particularly, to a joint positioning structure, which is durable in use.

2. Description of the Related Art

An electric wrench, vehicle battery charger, and any of a variety of objects may have a joint for allowing the user to change the angle between two parts for convenient operation or to fit a particular operation environment.

A joint of a vehicle battery charger is known comprising two coupling members pivotally coupled together and a positioning mechanism mounted in the pivot center between the two coupling members for allowing relative biasing between the two coupling members and locking the two coupling members to the desired angle. The positioning mechanism uses two engagement blocks to engage two locating holes in the two coupling members and to further lock the two coupling members. When the two engagement blocks are moved away from the locating holes, the two coupling members are unlocked and can be biased relative to each other.

According to the aforesaid design, the locating holes are directly formed on the coupling members for receiving the engagement blocks. Frequently engaging the engagement blocks into the locating holes and moving the engagement blocks away from the locating holes may cause the surrounding area of the coupling members to wear or to break. When the surrounding area of the coupling members starts to wear or is broken, the positioning between the coupling members may become in accurate or unable to achieve. In this case, the coupling members must be replaced. However, replacing the coupling members costs a lot.

### SUMMARY OF THE INVENTION

The present invention has been accomplished under the circumstances in view. It is one objective of the present invention to provide a joint positioning structure, which is durable in use.

It is another objective of the present invention to provide a joint positioning structure, which allows quick replacement of damaged parts.

To achieve these objectives of the present invention, the joint positioning structure comprises a first coupling member, a second coupling member pivoted to the first coupling member, and a locking mechanism adapted to lock the first coupling member and the second coupling member. The locking mechanism comprises a push rod, a spring member, a positioning member, a stop block and two engagement members. The push rod is inserted through the first coupling member and the second coupling member and movable relative to the first and second coupling members between a first position and a second position. The spring member is mounted on the push rod to support the push rod in the first position and to be compressed when the push rod is moved by an external force from the first position to the second position. The positioning member is affixed to the first coupling member and has a plurality of radial locating slots. The stop block is fixedly fastened to one end of the push rod and provided with at least one guide rail coupled to the second coupling member to guide reciprocating movement of the stop block with the push rod relative to the first and second coupling members. The stop block further has two locating grooves on one end edge thereof. The two engagement members are affixed to the locating grooves of the stop block. The two engagement members are engaged into the locating slots of the positioning member to lock the first and second coupling members when the stop member is moved with the push rod to the first position and disengaged from the locating slots of the positioning member to unlock the first and second coupling members when the stop member is moved with the push rod to the second position.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an exploded view of a joint positioning structure according to a preferred embodiment of the present invention;

FIG. 2 is a sectional assembly view of the joint positioning structure according to the preferred embodiment of the present invention, showing that the first coupling member and the second coupling member are unlocked with each other, and

FIG. 3 is similar to FIG. 2 but showing that the first coupling member and the second coupling member are locked with each other.

### DETAILED DESCRIPTION OF THE INVENTION

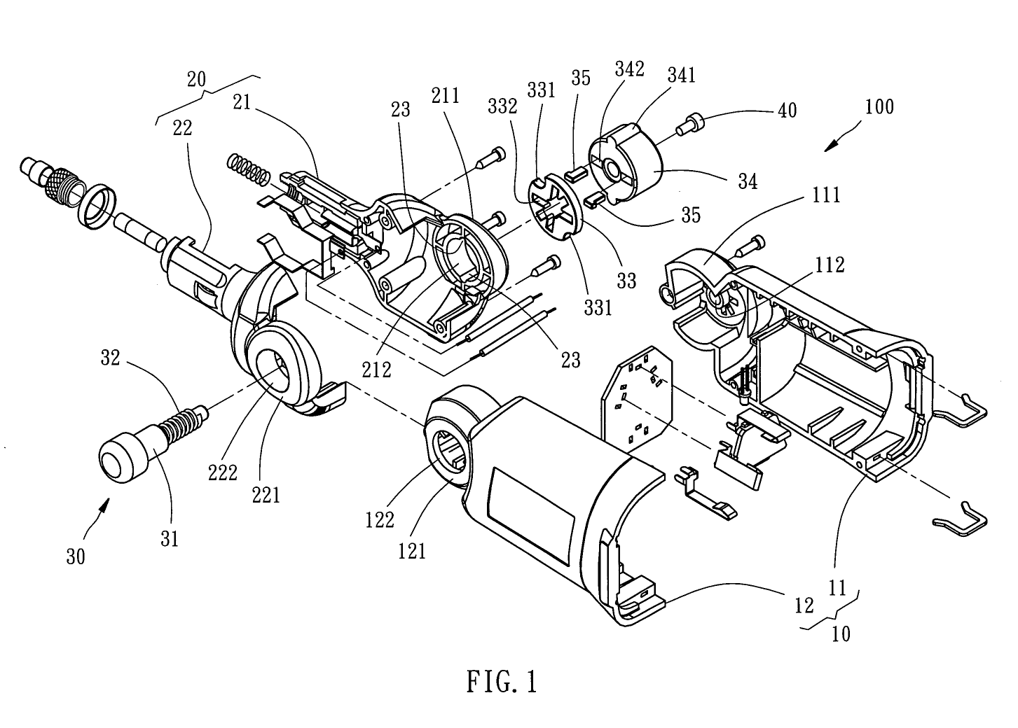

As shown in FIGS. 1-3, a joint positioning structure 100 in accordance with a preferred embodiment of the present invention comprises a first coupling member 10, a second coupling member 20 and a locking mechanism 30.

The first coupling member 10 is comprised of two symmetrical half shells 11 and 12. The two symmetrical half shells 11 and 12 are abutted against each other, each having a circular coupling portion 111 or 121 at one end and a through hole 112 or 122 through the two opposite lateral sides of the circular coupling portion 111 or 121. The axis of the through hole 112 or 122 is the axis of the circular coupling portion 111 or 121.

The second coupling member 20 is comprised of two symmetrical half shells 21 and 22. The two symmetrical half shells 21 and 22 are abutted against each other, each having a circular coupling portion 211 or 221 at one end and a through hole 212 or 222 through the two opposite lateral sides of the circular coupling portion 211 or 221. Further, one half shell 21 of the second coupling member 20 has two grooves 23 formed on the peripheral wall of the through hole 212 at two opposite sides and extending in the extending direction of the through hole 212. The circular coupling portions 211 and 221 of the second coupling member 20 are pivotally coupled to the circular coupling portions 111 and 121 of the first coupling member 10 so that the second coupling member 20 can be biased relative to the first coupling member 10 within a predetermined angle.

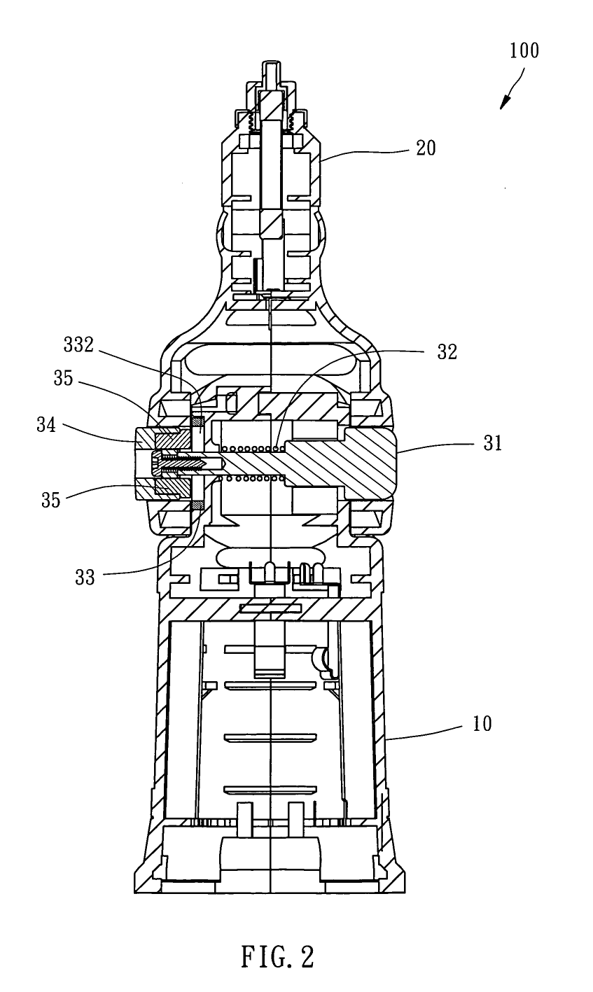

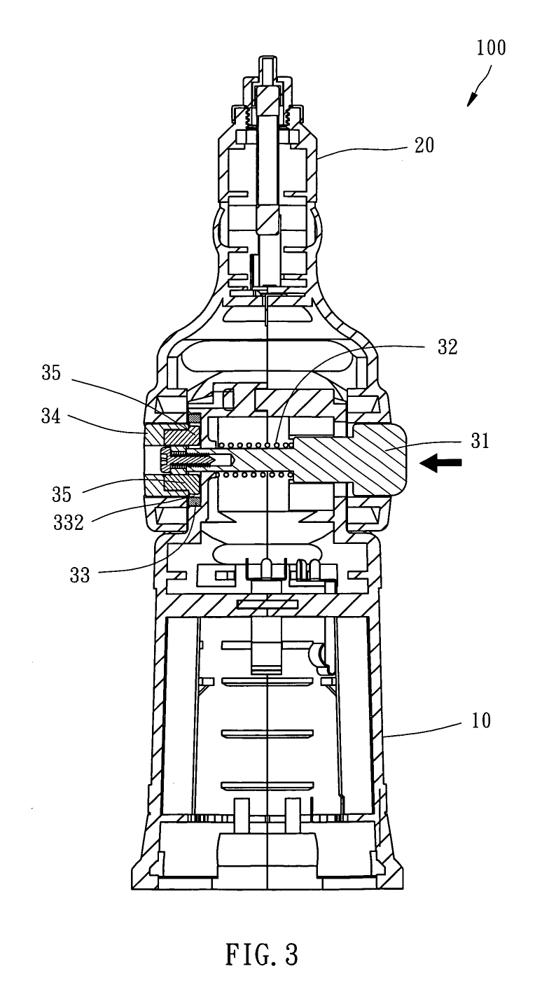

Referring to FIGS. 1 and 2 again, the locking mechanism 30 comprises a stepped push rod 31, a spring member 32, a positioning member 33, a stop block 34, and two engagement members 35. The stepped push rod 31 is inserted in proper order through the through hole 222 of the circular coupling portion 221 and the through hole 122 of the circular coupling portion 121 into the through hole 112 of the circular coupling portion 111. The spring member 32 is sleeved onto the stepped push rod 31 and stopped with its two distal ends respectively against a part (step) of the stepped push rod 31 and the inside wall of the circular coupling portion 111 to hold the stepped push rod 31 in a first position. The stepped push rod 31 can be moved from the first position to a second position when receiving an external force to compress the spring member 32. Therefore, the stepped push rod 31 is movable relative to the first and second coupling members 10 and 20 between the first position as shown in FIG. 3 and the second position as shown in FIG. 2. The positioning member 33 is shaped like a disc attached to the outer side of the circular coupling portion 111, having two opposite peripheral locating notches 331 respectively affixed to the circular coupling portion 111 for allowing the positioning member 33 to be moved with the circular coupling portion 111, and a plurality of radial locating slots 332. The stop block 34 has two guide rails 341 protruded from the periphery at two opposite sides, and two locating grooves 342 on one end edge. The engagement members 35 each have one end respectively press-fitted into the locating grooves 342 of the stop block 34 and the other end respectively protruded over the associating end edge of the stop block 34. The stop block 34 is inserted into the through hole 212 of the circular coupling portion 211 to force the guide rails 341 into the grooves 23. Therefore, the stop block 34 can only be moved linearly forwards and backwards in the through hole 212. Further, a screw 40 is inserted through the stop block 34 to affix the stop block 34 to the stepped push rod 31, for allowing synchronous movement of the stop block 34 with the stepped push rod 31.

After understanding of the parts of the joint positioning structure 100 and their relationship, the operation and main features of the joint positioning structure 100 are outlined hereinafter.

Referring to FIG. 3, when the stepped push rod 31 receives no external pressure, the spring member 32 supports the stepped push rod 31 in the first position. At this time, the stop block 34 holds the engagement members 35 in two locating slots 332 of the positioning member 33. Thus, the stop block 34 is prohibited from rotation relative to the circular coupling portion 221. As indicated above, the positioning member 33 is affixed to the circular coupling portion 111. Therefore, when the engagement members 35 are engaged into the locating slots 332 of the positioning member 33, the first coupling member 10 and the second coupling member 20 are locked and prohibited from biasing relative to each other.

Referring to FIG. 2, when wanting to bias the first coupling member 10 relative to the second coupling member 20 (or the second coupling member 20 relative to the first coupling member 10), the user can push the stepped push rod 31 from the first position to the second position to compress the spring member 32 and to move the stop block 34 and the engagement members 35 away from the locating slots 332 of the positioning member 33. Thus, the first coupling member 10 and the second coupling member 20 are unlocked. At this time, the user can bias the first coupling member 10 relative to the second coupling member 20, or bias the second coupling member 20 relative to the first coupling member 10. When the external push force applied to the stepped push rod 31 disappeared, the spring member 32 immediately pushes the stepped push rod 31 from the second position to the first position, and therefore the engagement members 35 are forced into the locating slots 332 of the positioning member 33 to lock the first coupling member 10 and the second coupling member 20 again.

As stated above, the invention controls locking/unlocking of the two coupling members by means of engagement/disengagement between the positioning member and the engagement members. Therefore, the positioning member and the engagement members must be made of a rigid material so that the positioning member and the engagement members do not wear easily after a long use. Further, because the positioning member and the engagement members are small and simple members, they are inexpensive. In case the positioning member or the engagement member is damaged, the replacement cost is low and not a burden to the user.

What is claimed is:

1. A joint positioning structure comprising:
a first coupling member;
a second coupling member pivoted to the first coupling member; and
a locking mechanism for locking the first coupling member and the second coupling member;
wherein the locking mechanism comprises a push rod inserted through the first coupling member and the second coupling member and movable relative to the first coupling member and the second coupling member between a first position and a second position, a spring member mounted on the push rod to support the push rod in the first position and to be compressed when the push rod is moved by an external force from the first position to the second position, a positioning member affixed to the first coupling member and having a plurality of radial locating slots, a stop block fixedly fastened to one end of the push rod and provided with at least one guide rail coupled to the second coupling member to guide reciprocating movement of the stop block with the push rod relative to the first coupling member and the second coupling member, and two locating grooves on one end edge thereof; and two engagement members affixed to the locating grooves of the stop block, engaged into the locating slots of the positioning member to lock the first coupling member and the second coupling member when the stop member is moved with the push rod to the first position and disengaged from the locating slots of the positioning member to unlock the first coupling member and the second coupling member when the stop member is moved with the push rod to the second position.

2. The joint positioning structure as claimed in claim 1, wherein the first coupling member comprises two symmetrical half shells abutted against each other, each half shell of the first coupling member having a circular coupling portion at one end and a through hole through two opposite lateral sides of the circular coupling portion; the second coupling member comprises two symmetrical half shells abutted against each other, each half shell of the second coupling member having a circular coupling portion disposed at one end and pivotally coupled to the circular coupling portions of the half shells of the first coupling member and a through hole through two opposite lateral sides of the circular coupling portion of the respective half shell; the locking mechanism is mounted in the through holes of the half shells of the first coupling member and the second coupling member.

3. The joint positioning structure as claimed in claim 1, wherein the second coupling member has at least one groove; the at least one guide rail of the stop block is coupled to the at least one groove of the second coupling member to guide movement of the stop block and the push rod relative to the first coupling member and the second coupling member.

4. The joint positioning structure as claimed in claim 1, wherein the positioning member has two peripheral locating notches formed on the periphery thereof at two opposite sides and affixed to the first coupling member.

5. The joint positioning structure as claimed in claim 1, wherein the stop block is affixed to one end of the push rod by a screw.

6. The joint positioning structure as claimed in claim 1, wherein the engagement members are made of a rigid material.

7. The joint positioning structure as claimed in claim 1, wherein the positioning member is made of a rigid material.
